(19) United States
(12) Patent Application Publication
(10) Pub. No.: US 2026/0273826 A1
(43) Pub. Date: Sep. 17, 2026

(54) LOW-SCALPING FILM FOR, PACKAGED FORMULATIONS

(71) Applicant: KENVUE BRANDS LLC, Summit, NJ (US)

(72) Inventors: William Panagiotis BELIAS, Pittsford, NY (US); Thomas S. CAMPBELL, Flemington, NJ (US); David A. LICKSTEIN, Chester, NJ (US); Stephanie Elizabeth SILVA, Richmond Hill, NY (US)

(21) Appl. No.: 19/311,340

(22) Filed: Aug. 27, 2025

Related U.S. Application Data
(60) Provisional application No. 63/687,986, filed on Aug. 28, 2024.

(51) Int. Cl. B29C 48/18; B29C 48/25; B29K 23/00; B29K 105/00

(52) U.S. Cl. CPC B29C 48/18; B29C 48/254; B29K 2023/38; B29K 2105/0085

(57) ABSTRACT

A multilayer flexible packaging material comprising cyclic olefin copolymer in the flowable formulation-contacting layer (“inner layer”) does not induce significant scalping of flowable formulations comprising essential oils such as eucalyptol, menthol, methyl salicylate and thymol in the presence of limonene.

### PRIORITY CLAIM

The present application claims priority to U.S. Provisional Application Ser. No. 63/687,986 filed Aug. 28, 2024, the entire contents of which is hereby incorporated by reference herein.

### FIELD OF THE INVENTION

The present invention relates generally to novel packaging constructs for flowable formulations, such as liquids, pastes, and gels that minimize scalping of packaged flowable formulations, packaged flowable formulations comprising said novel packaging constructs and methods of reducing scalping of packaged flowable formulations.

### BACKGROUND OF THE INVENTION

It is often preferable to package flowable formulations, especially consumer products in liquid, gel, and/or paste formulations, in durable, flexible pouches rather than hard plastic or glass containers to minimize materials costs, reduce product weight and improve the handling and use experience for the consumer. Key considerations for such pouches are that they should be durable—i.e., capable of withstanding mechanical pressure during production, shipment and ultimate handling by the consumer while preserving the packaged flowable formulation with minimal loss of any components of the packaged flowable formulation especially components known to be volatile or potentially mobile through the package. Such loss of components is known generally as “scalping”. The materials used in the flexible pouches are often selected to ensure that scalping is minimized. The extent of scalping depends on the composition of the flexible pouch and composition of the flowable formulation contained therein. Components of some flowable formulations may scalp when in contact with some packaging constructions but not with others.

Rivers, et. al., in US patent application 2009/0208685A1, purports to disclose packaging films that include semi-crystalline cyclic olefin copolymers, amorphous cyclic olefin copolymers, and/or cyclic olefin polymers present in the inner layer contacting a formulation and/or in the layer adjacent to the inner layer (in contact with the actual formulation) such that the film exhibits decreased scalping of essential oils, flavor compounds, antibacterial additives, antifungal additives, and the like from products packaged using the disclosed films. While films prepared from cyclic olefin copolymers were disclosed to reduce scalping of some formulation components, films comprised of the same cyclic olefin copolymers were found to disintegrate in the presence of limonene. It was concluded that limonene can cause swelling of the cyclic olefin copolymer and cause greater scalping of other compounds. Similarly, in a published presentation by Jester entitled “TOPAS® Cyclic Olefin Copolymers in Food Packaging-High Aroma Barrier Combined with Low Extractables” (presented at the 2005 Polymers, Laminations, Adhesives, Coatings, Extrusions or PLACE Conference in Las Vegas, NV), cyclic olefin copolymer is shown to measurably scalp d-Limonene.

Packaged flowable formulation products may contain alcohol solvents and/or essential oils, some of which contain limonene. There are no commercial product offerings of flexible pouches or other flexible packaging that reliably contain limonene without significant loss through the packaging materials or through scalping.

Some oral care compositions, such as LISTERINE® mouthwash contain essential oils, including limonene, and wines and other alcoholic beverages also contain essential oils including terpenoids, such as limonene (see M. Chigo-Hernandez and E. Tomasino, “Aroma Perception of Limonene, Linalool and alpha-Terpineol Combinations in Pinot Gris Wine,” Foods 2023, 12, 2389, https://doi.org/10.3390/foods12122389 and D. Slaghenaufi et al., “Monoterpenoids and norisoprenoids in Italian red wines,” OENO One 2022, Vol. 56-3, pp. 185-193).

Therefore, what is needed is an inner layer packaging film comprised of a cyclic olefin copolymer that retains key benefits such as processability, sealability and stability while minimizing scalping of formulation components in the presence of limonene. Such films can be used to manufacture packages or pouches of high mechanical integrity that could effectively preserve enclosed flowable formulation components including essential oils, such as limonene without significant scalping.

### SUMMARY OF THE INVENTION

We have found that a multilayer flexible packaging material comprising cyclic olefin copolymer in the flowable formulation-contacting layer (“inner layer”) does not induce significant scalping of flowable formulations comprising limonene.

In one embodiment, a multilayer flexible packaging material comprises an inner layer comprising one or more cyclic olefin copolymers, at least additional one polymeric layer comprising an olefin polymer or copolymer adjacent to the inner cyclic olefin copolymer layer, at least one intermediate polymeric layer comprising a polyamide, and at least one tie layer interposed between layers comprising an olefin polymer or copolymer and a layer comprising a polyamide.

In another embodiment, a packaged flowable formulation comprises (a) a flexible package having a perimeter and a heat seal disposed along the perimeter to define a reservoir and (b) a flowable formulation comprising a solvent and limonene disposed in the reservoir. The flexible package comprises first and second multilayer flexible film components, each component comprising an inner layer comprising one or more cyclic olefin copolymers; and at least one additional polymeric layer. The second multilayer flexible film component is disposed in facing relation to the first multilayer flexible film component with the inner layer of the first multilayer flexible film component is disposed in facing relation to the inner layer of the second multilayer flexible film component. liquid

In a third aspect of the present invention, a method of reducing scalping of a flowable oral care formulation comprising the step of interposing an inner cyclic olefin copolymer layer.

Further objects and advantages of the invention will be readily apparent to those skilled in the art from the following detailed description, taken in conjunction with the sheets of drawings.

### BRIEF DESCRIPTION OF THE DRAWINGS

FIG. 1 is a schematic drawing of a cross-section of an embodiment of a packaging film of the present invention.

FIG. 2 is a drawing of an embodiment of the present invention comprising a packaged flowable formulation according to the present invention. a packaging film of the present invention.

FIG. 2A is a drawing of an alternative embodiment of the present invention comprising a packaged flowable formulation according to the present invention.

FIG. 3 is a drawing of an alternative embodiment of the present invention comprising a packaged flowable formulation according to the present invention.

FIG. 4 is a schematic drawing of a cross-section of an alternative embodiment of a packaging film of the present invention.

FIG. 5 is a schematic drawing of a cross-section of an alternative embodiment of a packaging film of the present invention.

### DETAILED DESCRIPTION OF THE INVENTION

The present invention relates to novel packaging constructs for flowable formulations to minimize scalping of packaged flowable formulations products, packaged flowable formulations comprising said novel packaging constructs and methods of reducing scalping of packaged flowable formulations. A particularly difficult challenge exists to package flowable formulations containing eucalyptol, menthol, methyl salicylate, thymol and/or limonene. This can be made more difficult if one or more alcohols are present.

While the following terms are believed to be understood by one of ordinary skill in the art, the following definitions are set forth to facilitate explanation of the presently disclosed subject matter.

As used herein the specification and the claims, the term “scalp” or “scalping” and related terms mean a chemical interaction in which the concentration of a flavor, aroma, and the like in a product is reduced by the film used to package the product. The reduction in concentration can result from transport into or absorption by the film, by interaction of one or more film components with the flavor, aroma, etc., by adsorption onto the film, or by some other mechanism.

As used herein the specification and the claims, the term “limonene” and related terms mean the cyclic monoterpene that is a major component in the volatile oil of citrus fruit peels. Limonene is a chiral molecule, and biological sources such as citrus fruit produce one enantiomer, i.e., (+)-limonene (or d-limonene), which is the (R)-enantiomer. As used herein, the term “limonene” generally refers to (+)-limonene (or d-limonene).

The packaging constructs of this invention generally comprise multiple layers of various polymeric films. Two to twelve layers are generally preferred. Such multilayer films can be manufactured by co-extrusion, lamination or other methodologies known in the art. Co-extrusion is generally preferred over lamination due to typically better integrity of and between layers. The various layers of coextruded films adhere to each other through entanglement of long chain molecules in contrast to laminated films which are adhered with crosslinking adhesives. Crosslinking adhesives are often sensitive to migrating chemicals and especially essential oils which may dissolve such adhesives.

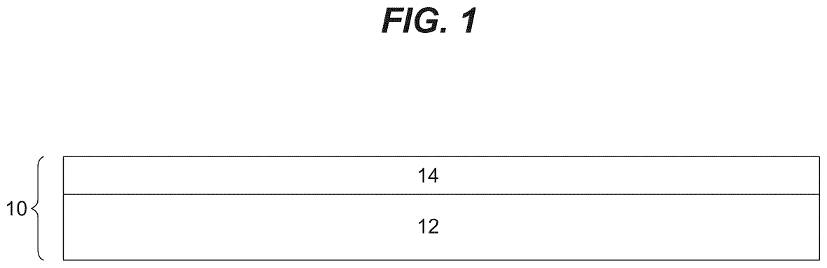

FIG. 1 illustrates some basic parameters of the coextruded film 10 of the present invention. The coextruded film 10 comprises a product-facing inner layer 12 and at least one additional layer 14. The inner layer 12 comprises one or more cyclic olefin copolymers and provides the unique anti-scalping properties of the coextruded film as well as providing adhesive properties when subjected to heat and pressure in the presence of another, similar layer. The at least one additional layer(s) 14 may provide desirable properties, such as tensile strength, impact resistance, toughness, durability, and other desirable flexible film package properties. The outer layer 14 may be similar to the inner layer—at least for co-extruded film forming processes as is known in the art. Therefore, in a preferred embodiment the outer layer also comprises one or more cyclic olefin copolymers.

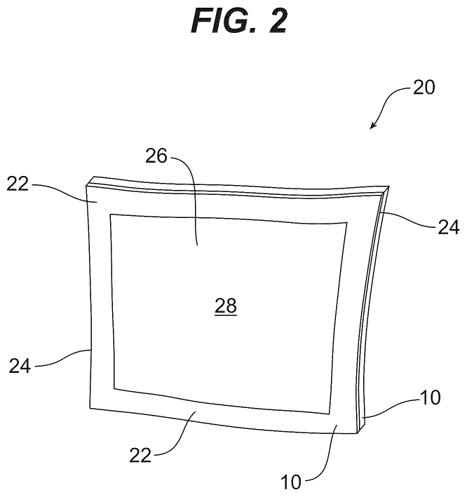

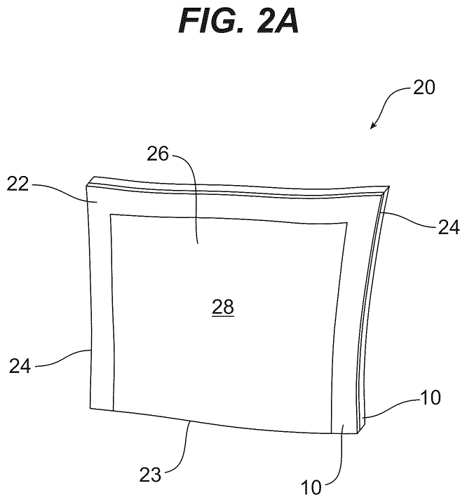

FIG. 2 illustrates a flexible film package 20 formed of two facing coextruded films 10 having a heat-seal 22 disposed along at least a portion of the perimeter 24 of the flexible film package 20. A portion of the perimeter 24 may be alternatively defined by a fold 23 as shown in FIG. 2A. The coextruded films 10 and heat seal 22 define a reservoir 26. The reservoir 26 may contain a liquid formulation 28 or other flowable product.

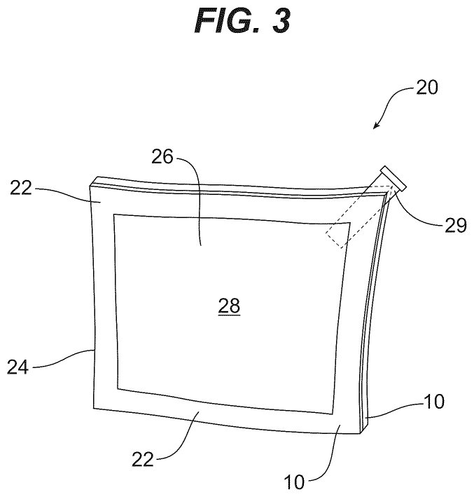

The flexible film package 20 may be a single-use sachet as shown in FIGS. 2 and 2A, or it may be a larger pouch having a closable spout 29 as shown in FIG. 3. Such larger pouches may be intended for multiple dispenses or as a refill for a re-usable container.

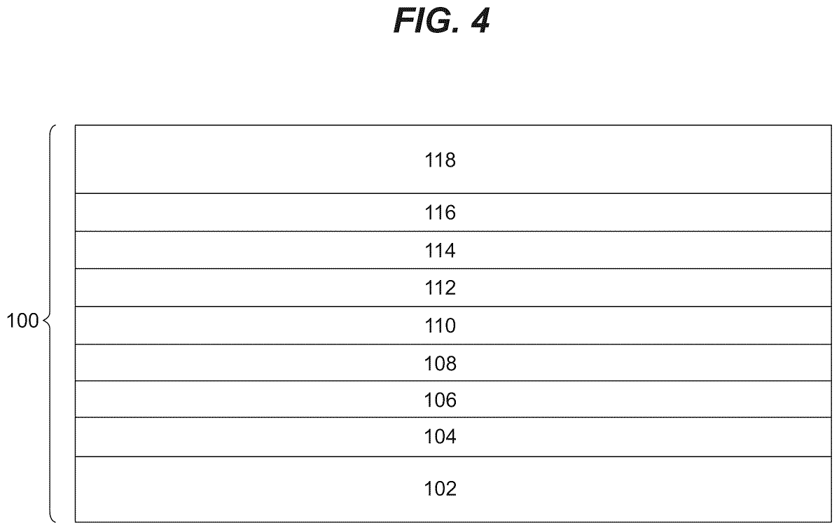

FIG. 4 illustrates an embodiment of a packaging film 100 of this invention having a core, structural component comprising a polyamide. The inner layer 102 (or layer contacting the flowable formulation) is comprised of cyclic olefin copolymer (“COC”). The layers immediately adjacent to the inner COC layer, 104 and 106, may comprise an ethylene/1-hexene copolymer to enhance the integrity of the bonding of adjacent layers. A tie layer 108 may be employed to enhance the integrity of the coextruded film comprising polyolefin and polyamide materials. Structural layers 110, 112 may follow to impart desirable qualities including toughness, durability, strength, etc. Again, a tie layer 114, may be used between the structural layers 110, 112 and additional layers 116, 118 (comprising an ethylene/1-hexene copolymer). Layer 118 may form the outer surface of the packaging film 100, or an additional polyolefin layer, such as COC or polyethylene may be used for enhanced appearance. While the foregoing structure may be formed using a nine-layer extruder, one of ordinary skill in the art will recognize that layers 104/106, 110/112, and 116/118 may be combined into single layers, e.g., in a six-layer extruder.

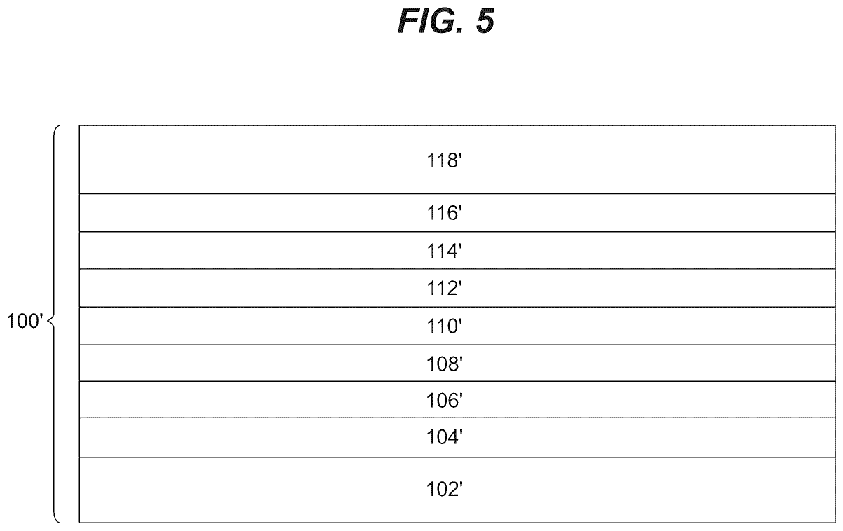

FIG. 5 illustrates an alternative embodiment of the packaging film 100′ of this invention having an outer, structural component comprising a polyamide. The inner layer 102′ (or layer contacting the flowable formulation) is comprised of cyclic olefin copolymer. The layers immediately adjacent to the inner COC layer, 104′, 106′, 108′, 110′, 112′, and 114′ may comprise an ethylene/1-hexene copolymer to enhance the integrity of the bonding of adjacent layers. A tie layer 116′ and a polyamide layer 118′ complete the coextruded film. While the foregoing structure may be formed using a nine-layer blown coextruded film process, one of ordinary skill in the art will recognize that layers 104′/106′/108′/110′/112′/114′ may be combined into a single layer, e.g., in processes with fewer extruders in the process. Coextruded film components:

There are three performance elements to the coextruded films for packaging of essential oil-containing flowable formulations: 1) strength and impact resistance to hold flowable formulations; 2) chemical resistance and scalping resistance of the inner layer; and 3) sealing capability to construct pouches. In order to achieve all three performance elements, a variety of layer types are unified into one film construction using the blown film coextrusion process. The strength of the multilayer construct or composite film is secured using nylon and polyethylene layers. Tie layers or adhesive layers are used to make the different polymer layers more compatible and thus can intermingle at the interface and adhere to each other. For example, maleic anhydride/linear, low-density polyethylene (LLDPE) copolymers are used as tie layers between nylon and polyethylene layers. The inner layer acts as a barrier to chemical migration and as a sealant layer and can be comprised of cyclic olefin copolymer as further described below.

In preferred embodiments, packaging films of this invention comprise a cyclic olefin copolymer (COC) inner layer which contacts the flowable formulation contents. Successive layers may then be comprised of olefin polymers and copolymers and polyamides with tie layers to enhance compatibility as further described below. In some embodiments, it is preferred that the core or intermediate layers of the multilayer packaging construct be comprised of polyamide, whereas, in other preferred embodiments, the intermediate layers are comprised of polyolefin polymers and copolymers. In embodiments wherein the intermediate layers are comprised of polyolefin polymers and copolymers, it is desirable to include a polyamide outer layer with a tie layer interposed between the outer layer and underlying layer comprising polyolefin polymers and copolymers.

Cyclic olefin copolymers (COCs) are copolymers of ethylene and norbornene. Semi-crystalline cyclic olefin copolymers are cyclic olefin copolymers that exist as liquids at temperatures above the melting point of the crystals. Some fraction of the copolymer remains uncrystallized, or amorphous, when cooled to room temperature. Particular semi-crystalline COCs suitable for use in this invention include, but are not limited to, COCs which have a glass transition temperature (T_{g}) in the range of about 70° C. to about 150° C. Particularly preferred grades of COC are Topas® 8007, Topas® 6013, and combinations thereof (available from Polyplastics Co., Ltd., Tokyo, Japan). Advantageously, Topas® 8007 has a broader melt processing window due to its relatively low glass transition temperature of 78° C. Topas® 6013 is still processible, but due to its higher T_{g} of 138° C., requires higher processing temperatures, which are potentially damaging to other packaging layers and packaged flowable formulations. Also owing to its improved processibility, the sealability of Topas® 8007 is typically better than that of Topas® 6013. For these reasons, Topas® 8007 is a preferred grade of COC. In some embodiments, it may be advantageous to form two layers of the Topas grades or to blend the two Topas grades into a compound that can then be coextruded. Such blending is carried out in a compounder extruder, which has the ability to intermingle the two polymers in a very well distributed manner. For example, a twin-screw extruder/compounder, such as the ZSK compounders available from Coperion GmbH, Stuttgart, Germany, with the appropriate kneading elements can be used to form pellets of the compounded Topas® 6013/8007 blend. This type of blending provides a polymer alloy that may advantageously provide a range of properties that are not achievable with either of the individual grades alone. For example, a 70:30 (w/w) blend of Topas® 8007 to Topas® 6013 can simultaneously provide a superior barrier to essential oils as well as more impact resistant seals when compared to results from the individual grades alone. Corresponding pouches made from the blend can also be sealed at lower temperatures compared to using Topas® 6013 alone. The thickness of the inner layer 102 can be from about 5 to about 75 microns or preferably between about 10 to about 60 microns.

An example of ethylene/1-hexene copolymer is ENABLE® 2005, available from Exxon Mobil Corporation, Spring Texas, USA. Advantageously, this polymer is sufficiently compatible with COC that a tie layer or adhesive is not required to assure a reliable, impact-resistant seal.

A tie layer between the ethylene/1-hexene copolymer and polyamide may be comprised of an ethylene/1-hexene copolymer and a maleic anhydride modified linear low-density polyethylene. A preferred grade of maleic anhydride modified linear low-density polyethylene is BONDYRAM® TL4110 available from Polyram, Plastic Industries, Ram-On, Israel. The ratio of ethylene/1-hexene copolymer to maleic anhydride modified linear low density polyethylene can be in a range 50:50 to 90:10 or preferably 60:40 to 80:20. This layer serves to promote adhesion between the pure ethylene/1-hexene copolymer layer(s) and the polyamide layer which comes next.

The structural element may comprise one or more polyamide layers. Nylon 6 (polycaprolactam) is a preferred polyamide. A preferred grade of nylon 6 is UBE Nylon 1030FDX34, available from UBE Corporation, Tokyo, Japan, which is a nucleated, high viscosity polyamide 6 homopolymer. This grade of nylon 6 is known to have good processability and good mechanical properties and has a melting point of 220° C. It is preferable to add an impact modifier to the polyamide layer(s) to improve toughness and durability. Preferred impact modifiers comprise maleic anhydride modified polyolefins. A preferred impact modifier is Sukano PA DC 5688, available from Sukano AG, Schindellegi, Switzerland. The ratio of polyamide to impact modifier may be 90:10 to 99:1 or preferably 95:5 to 98:2.

The overall thickness of the multilayer packaging film 10 may be from about 45 to about 165 microns, preferably from about 60 to about 150 microns.

The multilayer packaging films of this invention may be further processed into sachets or pouches using known manufacturing methods to enable the production of packaged flowable formulations. Sachets may contain about 10 to about 75 mL of flowable formulation contents. Sachets are generally sealed on all four sides with a means of opening provided on one side. Generally, sachets are intended for a single use. The means of opening the sachets include scores or perforations on one side of the sachet that can permit at least a portion of the sachet to be opened prior to consumption of the contents. Pouches can generally hold from about 75 to about 1500 mL of flowable formulation contents. Spouts may be incorporated into the pouches using known manufacturing methods. Such spouts have their own closures and may be opened and closed multiple times allowing for dispensing fractions of the flowable formulation contents during each use. The pouches may also be self-standing by incorporating gussets at the bottoms of the pouches. The gussets are fabricated by known methods that include folding and sealing the bottom of the pouches, which require film construction that seals well from both sides.

For both sachets and pouches, it is essential that the multilayer packaging films have sufficient seal strength and impact strength to withstand handling during manufacturing, shipping and use. In some embodiments, the seal strength and film strength are about 0.5 kg/inch (or 0.2 kg/cm) to about 3.0 kg/inch (or 1.2 kg/cm).

In a preferred embodiment of the present invention, the packaged flowable formulations are liquid formulations, such as alcoholic beverages. In such a preferred embodiment, any of a wide variety of alcoholic beverages may vary from containing between about 1 and about 35% w/w of ethanol, or between about 3 and about 25% w/w of ethanol, or between about 3 and about 20% w/w of ethanol or even between about 3 and about 15% w/w of ethanol. For example, beer, wine, mixed drinks, and even fortified beverages, such as limoncello. Beverages including limonene, for example those including citrus extracts, may be especially suitable to be packaged in the novel packaging of the present invention.

In another preferred embodiment of the present invention, the packaged flowable formulations are liquid formulations, such as mouthwashes and/or mouth rinses. In such a preferred embodiment, any of a wide variety of orally acceptable vehicles may be used in such compositions. The vehicle can be aqueous or non-aqueous. The aqueous vehicle is generally water, although water/ethanol mixtures may also be employed. In certain compositions, water is present in an amount of from about 50% to about 95% w/w of the total composition. In some embodiments, the ethanol may be present in the composition in an amount of about 10% to about 35% w/w of the total composition. In some embodiments, the compositions may comprise a reduced level of ethanol. The phrase “reduced level” of ethanol means an amount ethanol of about 10% w/w or less of the total composition. In certain embodiments, the compositions of the present invention are free of ethanol.

In certain embodiments, additional solvents may be added to the flowable formulations. The solvent may comprise a polyol or polyhydric alcohol selected from the group consisting of polyhydric alkanes (such as propylene glycol, glycerin, butylene glycol, hexylene glycol, 1,3-propanediol); polyhydric alkane esters (dipropylene glycol, ethoxydiglycol); polyalkene glycols (such as polyethylene glycol, polypropylene glycol) and mixtures thereof. In certain embodiments, the polyol solvent can be present in an amount of from 0% to about 30% w/w. The use of propylene glycol in reduced ethanol and ethanol free compositions is preferred.

In certain embodiments, a sugar alcohol is added to the flowable formulations of the present invention as a secondary solvent or humectant. The sugar alcohol may be selected from those multi-hydroxy-functional compounds that are conventionally used in oral and ingestible products. In specific embodiments, the sugar alcohols included, but are not limited to sorbitol, xylitol, mannitol, maltitol, inositol, allitol, altritol, dulcitol, galactitol, glucitol, hexitol, iditol, pentitol, ribitol, erythritol and mixtures thereof. Preferably, the sugar alcohol is sorbitol. In certain embodiments, the sugar alcohol can be present in an amount of from 0% to about 30% w/w.

In certain embodiments, compositions of the present invention comprise essential oils which may act as antimicrobial agents or flavor components. Essential oils are volatile aromatic oils which may be synthetic or may be derived from plants by distillation, expression or extraction, and which usually carry the odor or flavor of the plant from which they are obtained. Useful essential oils may provide antiseptic activity. Some of these essential oils also act as flavoring agents. Useful essential oils include but are not limited to citral, thymol, menthol, methyl salicylate (wintergreen oil), eucalyptol, carvacrol, camphor, anethole, carvone, eugenol, isoeugenol, limonene, n-decyl alcohol, methyl acetate, citronellyl acetate, methyl eugenol, cineol, linalool, ethyl linalool, vanillin, spearmint oil, peppermint oil, lemon oil, orange oil, sage oil, rosemary oil, cinnamon oil, pimento oil, laurel oil, cedar leaf oil, gerianol, verbenone, anise oil, bay oil, benzaldehyde, bergamot oil, bitter almond, chlorothymol, cinnamic aldehyde, citronella oil, clove oil, eucalyptus oil, guaiacol, tropolone derivatives such as hinokitiol, lavender oil, mustard oil, phenol, phenyl salicylate, pine oil, pine needle oil, sassafras oil, spike lavender oil, storax, thyme oil, tolu balsam, turpentine oil, clove oil, and combinations thereof.

In certain embodiments, the essential oils are selected from the group consisting of thymol (also known as isopropyl-m-cresol), eucalyptol (also known as cineol), menthol (also known as hexahydrothymol), methyl salicylate (also known as wintergreen oil), isomers of each of these compounds, and combinations of two or more thereof. Notably, eucalyptol comprises about 0.3% limonene. In some embodiments, the composition contains all four of these essential oils. In certain embodiments, thymol is employed in amounts of from about 0.0001% to about 0.6% w/w, or preferably from about 0.005% to about 0.1% w/w of the composition. In certain embodiments, eucalyptol may be employed in amounts of from about 0.0001% to about 0.5% w/w, or preferably from about 0.005% to about 0.1% w/w of the composition. In certain embodiments, menthol is employed in amounts of from about 0.0001% to about 0.25% w/w, or preferably from about 0.005% to about 0.1% w/w of the composition. In certain embodiments, methyl salicylate is employed in amounts of from about 0.0001% to about 0.28% w/w, or preferably from about 0.005% to about 0.1% w/w of the composition. In certain embodiments, the total amount of all of such essential oils present in the disclosed compositions can be from about 0.0004% to about 1.63% w/w, or preferably from about 0.02% to about 0.4% w/w of the composition.

In certain embodiments, the flowable formulations may comprise one or more surfactants. Suitable surfactants may include anionic, non-ionic, cationic, amphoteric, zwitterionic surfactants, and combinations of two or more thereof. Non-ionic surfactants include, but are not limited to, compounds produced by the condensation of alkylene oxide groups (hydrophilic in nature) with an organic hydrophobic compound which may be aliphatic or alkyl-aromatic in nature. Examples of suitable nonionic surfactants include, but are not limited to, alkyl polyglucosides; alkyl glucose amines, block copolymers such as ethylene oxide and propylene oxide copolymers, e.g., Poloxamers; ethoxylated hydrogenated castor oils; alkyl polyethylene oxide, e.g., Polysorbates, and/or; fatty alcohol ethoxylates; polyethylene oxide condensates of alkyl phenols; products derived from the condensation of ethylene oxide with the reaction product of propylene oxide and ethylene diamine; ethylene oxide condensates of aliphatic alcohols; long chain tertiary amine oxides; long chain tertiary phosphine oxides; long chain dialkyl sulfoxides; and mixtures thereof. Poloxamer 407 is a preferred non-ionic surfactant.

In certain embodiments, the compositions of the claimed invention comprise less than about 9% w/w of non-ionic surfactant(s), less than 5%, or less than 1.5%, or less than 1%, or less than 0.5% w/w of non-ionic surfactant(s). In certain embodiments, the composition of the present invention is free of non-ionic surfactant(s).

In certain embodiments, anionic surfactants are incorporated into the flowable formulations. Suitable anionic surfactants include but are not limited to sarcosine type surfactants or sarcosinates; taurates such as sodium methyl cocoyl taurate; alkyl sulfates such as sodium trideceth sulfate or sodium lauryl sulfate; sodium lauryl sulfoacetate; sodium lauroyl isethionate; sodium laureth carboxylate; sodium dodecyl benzenesulfonate and mixtures thereof. Sodium methyl cocoyl taurate is a preferred anionic surfactant. When included, anionic surfactants may be present in the compositions of the present invention from about 0.1% to about 2.5%, or from about 0.5% to about 2% w/w of the composition.

In certain embodiments, the compositions of the present invention also contain at least one alkyl sulfate surfactant. In certain embodiments, suitable alkyl sulfate surfactants include, but are not limited to sulfated C8 to C18, optionally sulfated C10 to C16 even numbered carbon chain length alcohols neutralized with a suitable basic salt such as sodium carbonate or sodium hydroxide and mixtures thereof such that the alkyl sulfate surfactant has an even numbered C8 to C18, optionally C10 to C16, chain length. In certain embodiments, the alkyl sulfate is selected from the group consisting of sodium lauryl sulfate, hexadecyl sulfate and mixtures thereof. In certain embodiments, commercially available mixtures of alkyl sulfates are used. When included, alkyl sulfate surfactants may be present in the compositions of the present invention from about 0.1% to about 2.5%, or from about 0.5% to about 2% w/w of the composition.

The composition can optionally comprise at least one pH modifying agent among those useful herein include acidifying agents to lower pH, basifying agents to raise pH, and buffering agents to control pH within a desired range. One or more pH modifying agents are optionally present in a total amount effective to maintain the composition in an orally acceptable pH range. In certain embodiments, inorganic acids may be used as the buffer added to the composition. In some embodiments, phosphoric acid is the inorganic acid. In certain embodiments, organic acids may be used as the buffer added to the composition. Organic acids suitable for use in the compositions of the present invention include, but are not limited to, ascorbic acid, sorbic acid, citric acid, glycolic acid, lactic acid, acetic acid, benzoic acid, salicylic acid, phthalic acid, phenolsulphonic acid, and mixtures thereof. Preferably, the organic acid is selected from the group consisting of benzoic acid, sorbic acid, citric acid and mixtures thereof, and more preferably, the organic acid is benzoic acid.

In some embodiments, useful buffer systems have been found to be sodium benzoate/benzoic acid, sodium citrate/citric acid, sodium phosphate/phosphoric acid. Generally, the amount of buffer is between about 0.001% to about 5.0% w/w of the composition.

The compositions of the present invention may further comprise any of a variety of optional ingredients therein, including, but not limited to, flavors, sweeteners, colorants, preservatives, and the like.

Sweeteners such as aspartame, sodium saccharin (saccharin), sucralose, stevia, acesulfame K and the like may be added for better taste in amounts of from about 0.0001% to about 1% w/w. In certain preferred embodiments, the sweetener comprises sucralose.

In certain embodiments, the composition further comprises flavors or flavorants to modify or magnify the taste of the composition or reduce or mask the sharp “bite” or “burn” of ingredients such as thymol. Suitable flavors include, but are not limited to, flavor oils such as oil of anise, anethole, benzyl alcohol, spearmint oil, citrus oils, vanillin and the like. In these embodiments, the amount of flavor oil added to the composition can be from about 0.001% to about 5% w/w. The particular flavors or flavorants, and other taste improving ingredients, employed will vary depending upon the particular taste and feel desired. Those skilled in the art can select and customize these types of ingredients to provide the desired results.

In certain embodiments, acceptably approved colorants such as food dyes may be used to provide a pleasing color to the compositions of the invention. These may be selected from, but not limited to, the list of acceptable food dyes. Suitable dyes for this purpose include FD&C yellow No. 5, FD&C yellow No. 10, FD&C blue No. 1 and FD&C green No. 3. These are added in conventional amounts, typically in individual amounts of from about 0.00001 to about 0.001% w/w of the composition.

In some embodiments, antimicrobial preservatives or other ingredients providing a benefit to the oral cavity may be added to the composition. Some antimicrobial preservatives which may be used include, but are not limited to cationic antibacterials, such as sodium benzoate, polyquaternium polycationic polymers, quaternary ammonium salts, ternary ammonium compounds, parabens, cetylpyridinium chloride (CPC), tetradecylpyridinium chloride (TPC), N-tetradecyl-4-ethyl pyridinium chloride (TDEPC), octenidine, bisbiguanides, zinc or stannous ion agents including zinc chloride, grapefruit extract, and mixtures thereof. Other antibacterial and antimicrobial agents include, but are not limited to: 5-chloro-2-(2,4-dichlorophenoxy)-phenol, commonly referred to as triclosan; 8-hydroxyquinoline and its salts, copper II compounds, including, but not limited to, copper (II) chloride, copper (II) sulfate, copper (II) acetate, copper (II) fluoride and copper (II) hydroxide; phthalic acid and its salts, sanguinarine, salicylanilide, iodine, sulfonamides, phenolics, delmopinol, octapinol, and other piperidino derivatives, niacin preparations, nystatin, apple extract, antibiotics such as amoxicillin, tetracycline, doxycycline, minocycline, metronidazole, neomycin, kanamycin, clindamycin, analogs and salts of the above, hydrogen peroxide, metal salts of chlorite, pyrrolidone ethyl cocoyl arginate, lauroyl ethyl arginate monochlorohydrate, and mixtures of all of the above. Sodium fluoride may also be added as cavity-prevention agent. Antimicrobial components or ingredients providing a benefit to the oral cavity may be present from about 0.001% to about 20% by weight of the oral care composition. In another embodiment, the antimicrobial agents or ingredients providing a benefit to the oral cavity generally comprise from about 0.1% to about 5% w/w of the composition of the present invention.

### EXAMPLES

### Example 1—Nylon Core—80-Micron Total Thickness

A 9-layer co-extruded film useful for forming a pouch was prepared using the following polymeric resins:
Topas 8007F-600: amorphous cyclic olefin ethylene-norbornene copolymer resin with a glass transition temperature (T_{g}) of 78° C.
Exxon Enable 2005: ethylene, 1-hexene copolymer resin with a Vicat softening temperature of 107° C.
UBE Nylon 1030 FDX34N: Nylon 6 (polycaprolactam) homopolymer with a melting point of 220° C.
Sukano PA DC 5688: impact modifier comprising maleic anhydride modified polyolefin
Bondyram TL4110: maleic anhydride modified linear low density polyethylene

| | | Percentage of Each Resin in Layer | | | | | |
|---|---|---|---|---|---|---|---|
| Layer | | | | UBE | | | |
| (labelled | | Topas | Exxon | Nylon | Sukano | | |
| as shown | Thickness | 8007F- | Enable | 1030 | PA DC | Bondyram | |
| in FIG. 4) | (microns) | 600 | 2005 | FDX34N | 5688 | TL4110 | Total |
| 102 | 17 | 100 | | | | | 100 |
| (seal/ | | | | | | | |
| inner) | | | | | | | |
| 104 | 7 | | 100 | | | | 100 |
| 106 | 6 | | 100 | | | | 100 |
| 108 | 7 | | 70 | | | 30 | 100 |
| 110 | 8 | | | 97 | 3 | | 100 |
| 112 | 7 | | | 97 | 3 | | 100 |
| 114 | 6 | | 70 | | | 30 | 100 |
| 116 | 7 | | 100 | | | | 100 |
| 118 | 15 | | 100 | | | | 100 |
| (outer) | | | | | | | |
| Total | 80 | | | | | | |

### Multi-Layer Blown Film Coextrusion Preparation

The 9-layer blown film described above was prepared using a Dr. Collins 9-layer extrusion manufacturing line, which consisted of nine extruders feeding into a 9-layer coextrusion annular die. Layer thicknesses were achieved by varying the speed that each extruder was operated on. The annular die created a tube which was pulled by a two-roll nip. The nip pulled the tube continuously and was about 2 feet from the annular die. The tube was inflated through the center of the die with air and that stretched the film using internal pressure until the film was of a desired thickness. The nip also pulled the film to stretch it in the machine direction. The two stretching directions resulted in a balanced orientation of the polymer molecules.

A pouch was formed by sealing two co-extruded films described above with a heat seal around the perimeter of the pouch (Topas 8007F-600 layers in face-to-face relation) using a Labthink Heat Sealer, model C630H, available from Labthink, Boston, Massachusetts, USA at 270 degrees C. with a two second dwell time. The resulting seal strength was measured according to ASTM F1921, and the Machine Direction strength was measured as 1200 g/15 mm, and Cross Direction strength was measured as 900 g/15 mm.

A commercially available mouthwash formula (LISTERINE® Cool Mint) was filled in the pouch described above. The formulation was as follows:

| | Percentage | |
|---|---|---|
| Component | (% w/w) | Function |
| Ethanol (190 Proof) | 18.19016 | Solvent |
| Menthol | 0.03440 | Antimicrobial agent |
| Thymol | 0.06330 | Antimicrobial agent |
| Methyl salicylate | 0.06528 | Antimicrobial agent |
| Eucalyptol (containing | 0.09026 | Antimicrobial agent |
| 0.3% limonene) | | |
| Poloxamer 407 | 0.24534 | Surfactant |
| Benzoic acid | 0.10943 | pH modifying agent |
| Sodium benzoate | 0.04458 | pH modifying agent |
| Sodium saccharin | 0.11482 | Sweetener |
| Sorbitol solution | 16.00000 | Humectant |
| (70% sorbitol in water) | | |
| Coolmint flavor | 0.02810 | Flavorant |
| FD&C Green No. 3 dye | 0.00049 | Colorant |
| Purified water | 65.01384 | Solvent |
| Total | 100.00000 | |

### Example 2—Nylon Outer Layer—93-Micron Total Thickness

| | | Percentage of Each Resin in Layer | | | | | |
|---|---|---|---|---|---|---|---|
| Layer | | | | UBE | | | |
| (labelled | | Topas | Exxon | Nylon | Sukano | | |
| as shown | Thickness | 8007F- | Enable | 1030 | PA DC | Bondyram | |
| in FIG. 5) | (microns) | 600 | 2005 | FDX34N | 5688 | TL4110 | Total |
| 102′ | 30 | 100 | | | | | 100 |
| (seal/ | | | | | | | |
| inner) | | | | | | | |
| 104′ | 7 | | 100 | | | | 100 |
| 106′ | 6 | | 100 | | | | 100 |
| 108′ | 7 | | 100 | | | | 100 |
| 110′ | 8 | | 100 | | | | 100 |
| 112′ | 7 | | 100 | | | | 100 |
| 114′ | 6 | | 100 | | | | 100 |
| 116′ | 7 | | 70 | | | 30 | 100 |
| 118′ | 15 | | | 97 | | 3 | 100 |
| (outer) | | | | | | | |
| Total | 93 | | | | | | |

The multilayered packaging film was manufactured under similar conditions as described in Example 1. A pouch was then formed and filled with the same liquid mouthwash composition, also as described in Example 1.

### Example 3—Nylon Outer Layer—113-Micron Total Thickness

| | | Percentage of Each Resin in Layer | | | | | |
|---|---|---|---|---|---|---|---|
| Layer | | | | UBE | | | |
| (labelled | | Topas | Exxon | Nylon | Sukano | | |
| as shown | Thickness | 8007F- | Enable | 1030 | PA DC | Bondyram | |
| in FIG. 5) | (microns) | 600 | 2005 | FDX34N | 5688 | TL4110 | Total |
| 102′ | 50 | 100 | | | | | 100 |
| (seal/ | | | | | | | |
| inner) | | | | | | | |
| 104′ | 7 | | 100 | | | | 100 |
| 106′ | 6 | | 100 | | | | 100 |
| 108′ | 7 | | 100 | | | | 100 |
| 110′ | 8 | | 100 | | | | 100 |
| 112′ | 7 | | 100 | | | | 100 |
| 114′ | 6 | | 100 | | | | 100 |
| 116′ | 7 | | 70 | | | 30 | 100 |
| 118′ | 15 | | | 97 | | 3 | 100 |
| (outer) | | | | | | | |
| Total | 113 | | | | | | |

The multilayered packaging film was manufactured under similar conditions as described in Example 1. A pouch was then formed and filled with the same liquid mouthwash composition, also as described in Example 1.

### Example 4—Evaluation of Blends of Topas® 6013 and Topas® 8007

Blends of Topas® 6013 and Topas® 8007, in the ratios specified below, were prepared by blending in a ZSK twin-screw extruder/compounder extruder (Coperion GmbH, Stuttgart, Germany). The blends were extruded at a temperature range of 230-250° C. The resulting extrudates were water-cooled and cut to form pellets (2 mm diameter by 4 mm length) of the compounded blends.

| Example | Parts Topas ® 6013 | Parts Topas ® 8007 |
|---|---|---|
| 4A | 0 | 100 |
| 4B | 25 | 75 |
| 4C | 50 | 50 |
| 4D | 75 | 25 |
| 4E | 100 | 0 |

Each of the pellet types summarized above were immersed in the liquid mouthwash composition described in Example 1 by adding 3 grams of pellets to 20 mL of liquid mouthwash composition. These test samples were then stored for 12 weeks at 25° C. and 40° C. To monitor the degree of scalping of the essential oils into the pellets, the concentration of eucalyptol, menthol, methyl salicylate and thymol were measured by gas chromatography just before pellet addition (week 0) and after storage at 2, 4 and 12 weeks. The concentrations of each essential oil in the test samples were then compared to a control sample of the liquid mouthwash composition (without added pellets) stored in the same manner. The results were as follows:

Results after storage at 25° C.

| | | Concentration mg/ml | | | |
|---|---|---|---|---|---|
| Exam- | Week | | | Methyl | |
| ple | Number | Eucalyptol | Menthol | Salicylate | Thymol |
| 4A | 0 | 0.910 | 0.418 | 0.621 | 0.664 |
| | 2 | 0.885 | 0.409 | 0.601 | 0.653 |
| | 4 | 0.888 | 0.415 | 0.596 | 0.658 |
| | 12 | 0.863 | 0.407 | 0.575 | 0.646 |
| | % remaining at | 93.89% | 96.90% | 91.32% | 97.33% |
| | 12 weeks | | | | |
| 4B | 0 | 0.915 | 0.419 | 0.622 | 0.663 |
| | 2 | 0.902 | 0.413 | 0.606 | 0.655 |
| | 4 | 0.909 | 0.421 | 0.601 | 0.665 |
| | 12 | 0.894 | 0.414 | 0.580 | 0.653 |
| | % remaining at | 97.31% | 98.62% | 92.20% | 98.33% |
| | 12 weeks | | | | |
| 4C | 0 | 0.915 | 0.419 | 0.623 | 0.664 |
| | 2 | 0.904 | 0.413 | 0.604 | 0.656 |
| | 4 | 0.912 | 0.420 | 0.602 | 0.663 |
| | 12 | 0.897 | 0.414 | 0.581 | 0.650 |
| | % remaining at | 97.58% | 98.54% | 92.31% | 97.87% |
| | 12 weeks | | | | |
| 4D | 0 | 0.909 | 0.415 | 0.619 | 0.656 |
| | 2 | 0.904 | 0.413 | 0.605 | 0.655 |
| | 4 | 0.913 | 0.419 | 0.602 | 0.661 |
| | 12 | 0.899 | 0.415 | 0.582 | 0.653 |
| | % remaining at | 97.84% | 98.85% | 92.41% | 98.42% |
| | 12 weeks | | | | |
| 4E | 0 | 0.909 | 0.414 | 0.620 | 0.657 |
| | 2 | 0.899 | 0.412 | 0.603 | 0.653 |
| | 4 | 0.912 | 0.421 | 0.598 | 0.663 |
| | 12 | 0.897 | 0.414 | 0.580 | 0.653 |
| | % remaining at | 97.59% | 98.66% | 92.11% | 98.36% |
| | 12 weeks | | | | |
| Control | 0 | 0.919 | 0.420 | 0.629 | 0.664 |
| | 2 | 0.903 | 0.412 | 0.614 | 0.652 |
| | 4 | 0.917 | 0.422 | 0.616 | 0.667 |
| | 12 | 0.900 | 0.416 | 0.604 | 0.656 |
| | % remaining at | 97.96% | 99.01% | 95.90% | 98.79% |
| | 12 weeks | | | | |

Significantly higher concentrations of the essential oils were retained when 25 parts or greater amounts of Topas® 6013 were incorporated in the blends when the test samples were stored at 25° C.

### Results After Storage at 40° C.

| Exam- | Week | | | Methyl | |
|---|---|---|---|---|---|
| ple | Number | Eucalyptol | Menthol | Salicylate | Thymol |
| 4A | 0 | 0.910 | 0.418 | 0.621 | 0.664 |
| | 2 | 0.838 | 0.397 | 0.568 | 0.638 |
| | 4 | 0.833 | 0.401 | 0.556 | 0.642 |
| | 12 | 0.796 | 0.392 | 0.522 | 0.632 |
| | % remaining at | 86.66% | 93.31% | 83.00% | 95.19% |
| | 12 weeks | | | | |
| 4B | 0 | 0.915 | 0.419 | 0.622 | 0.663 |
| | 2 | 0.863 | 0.403 | 0.573 | 0.643 |
| | 4 | 0.858 | 0.406 | 0.560 | 0.646 |
| | 12 | 0.825 | 0.398 | 0.525 | 0.637 |
| | % remaining at | 89.77% | 94.72% | 83.42% | 95.97% |
| | 12 weeks | | | | |
| 4C | 0 | 0.915 | 0.419 | 0.623 | 0.664 |
| | 2 | 0.875 | 0.405 | 0.575 | 0.646 |
| | 4 | 0.880 | 0.413 | 0.567 | 0.654 |
| | 12 | 0.851 | 0.403 | 0.534 | 0.638 |
| | % remaining at | 92.59% | 95.84% | 84.78% | 96.20% |
| | 12 weeks | | | | |
| 4D | 0 | 0.909 | 0.415 | 0.619 | 0.656 |
| | 2 | 0.879 | 0.406 | 0.579 | 0.646 |
| | 4 | 0.878 | 0.413 | 0.564 | 0.656 |
| | 12 | 0.853 | 0.403 | 0.532 | 0.642 |
| | % remaining at | 92.82% | 95.95% | 84.60% | 96.69% |
| | 12 weeks | | | | |
| 4E | 0 | 0.909 | 0.414 | 0.620 | 0.657 |
| | 2 | 0.882 | 0.407 | 0.579 | 0.648 |
| | 4 | 0.881 | 0.411 | 0.566 | 0.652 |
| | 12 | 0.851 | 0.402 | 0.532 | 0.639 |
| | % remaining at | 92.61% | 95.81% | 84.47% | 96.27% |
| | 12 weeks | | | | |
| Control | 0 | 0.919 | 0.420 | 0.629 | 0.664 |
| | 2 | 0.879 | 0.406 | 0.592 | 0.645 |
| | 4 | 0.889 | 0.415 | 0.589 | 0.659 |
| | 12 | 0.856 | 0.405 | 0.559 | 0.642 |
| | % remaining at | 93.13% | 96.34% | 88.82% | 96.77% |
| | 12 weeks | | | | |

Significantly higher concentrations of the essential oils were retained when 25 parts of Topas® 6013 were incorporated in the blends when the test samples were stored at 40° C. Further increases in % remaining were observed when Topas® 6013 levels of 50 and 75 parts were incorporated in the blends.

What is claimed is:

1. A packaged flowable formulation comprising:
a) flexible package having a perimeter comprising
i) a first multilayer flexible film component comprising:
A) an inner layer comprising one or more cyclic olefin copolymers; and
B) at least one additional polymeric layer; and
ii) a second multilayer flexible film component comprising:
A) an inner layer comprising one or more cyclic olefin copolymers; and
B) at least one additional polymeric layer; and
iii) a heat seal disposed along at least a portion of the perimeter of the flexible package;
wherein the second multilayer flexible film component is disposed in facing relation to the first multilayer flexible film component with the inner layer of the first multilayer flexible film component is disposed in facing relation to the inner layer of the second multilayer flexible film component and the first and second multilayer flexible film components and the heat seal define a reservoir; and
b) a flowable formulation disposed in the reservoir, the flowable formulation comprising a solvent and limonene.

2. The packaged flowable formulation of claim 1 wherein the inner layer of the first multilayer flexible film component comprises a coextruded layer of two or more cyclic olefin copolymers and the inner layer of the second multilayer flexible film component comprises a coextruded layer of the two or more cyclic olefin copolymers.

3. The packaged flowable formulation of claim 2 wherein the inner layer of the first multilayer flexible film component comprises a blend of two or more cyclic olefin copolymers and the inner layer of the second multilayer flexible film component comprises a blend of the two or more cyclic olefin copolymers.

4. The packaged flowable formulation of claim 1 wherein the first and second multilayer flexible film components are defined by a fold in a multilayer flexible film by which the second multilayer flexible film component is disposed in facing relation to the first multilayer flexible film component and remaining edges of the two multilayer flexible film components are sealed along the perimeter of the flexible package.

5. The packaged flowable formulation of claim 1 wherein the first and second multilayer flexible film components are individual multilayer flexible films that are sealed along the perimeter of the flexible package.

6. The packaged flowable formulation of claim 1 wherein the flexible package further comprises a spout.

7. The packaged flowable formulation of claim 1 wherein the limonene is a component of eucalyptol, and the flowable further comprises one or more essential oils selected from the group consisting of menthol, methyl salicylate and thymol.

8. The packaged flowable formulation of claim 1 wherein the solvent comprises at least one alcohol selected from the group consisting of ethanol and polyols.

9. A packaged liquid formulation comprising:
a) flexible package having a perimeter comprising
i) a first multilayer flexible film component comprising:
A) an inner layer comprising one or more cyclic olefin copolymers; and
B) at least one additional polymeric layer; and
ii) a second multilayer flexible film component comprising:
A) an inner layer comprising one or more cyclic olefin copolymers; and
B) at least one additional polymeric layer; and
iii) a heat seal disposed along at least a portion of the perimeter of the flexible package;
wherein the second multilayer flexible film component is disposed in facing relation to the first multilayer flexible film component with the inner layer of the first multilayer flexible film component is disposed in facing relation to the inner layer of the second multilayer flexible film component and the first and second multilayer flexible film components and the heat seal define a reservoir; and
b) a liquid disposed in the reservoir, the liquid comprising water, between about 1 and about 35% w/w alcohol, and at least one essential oil.

10. The packaged liquid formulation of claim 9 wherein the inner layer of the first multilayer flexible film component comprises a coextruded layer of two or more cyclic olefin copolymers and the inner layer of the second multilayer flexible film component comprises a coextruded layer of the two or more cyclic olefin copolymers.

11. The packaged liquid formulation of claim 10 wherein the inner layer of the first multilayer flexible film component comprises a blend of two or more cyclic olefin copolymers and the inner layer of the second multilayer flexible film component comprises a blend of the two or more cyclic olefin copolymers.

12. The packaged liquid formulation of claim 9 wherein the first and second multilayer flexible film components are defined by a fold in a multilayer flexible film by which the second multilayer flexible film component is disposed in facing relation to the first multilayer flexible film component and remaining edges of the two multilayer flexible film components are sealed along the perimeter of the flexible package.

13. The packaged liquid formulation of claim 9 wherein the first and second multilayer flexible film components are individual multilayer flexible films that are sealed along the perimeter of the flexible package.

14. The packaged liquid formulation of claim 9 wherein the flexible package further comprises a spout.

15. The packaged liquid formulation of claim 9 wherein the at least one essential oil is selected from the group consisting of limonene, menthol, methyl salicylate and thymol.

16. The packaged liquid formulation of claim 9 wherein the alcohol comprises ethanol.

17. The packaged liquid of claim 16 wherein the liquid comprises between about 3 and about 20% w/w ethanol.

18. The packaged liquid of claim 17 wherein the liquid comprises between about 3 and about 15% w/w ethanol.

19. A method of reducing scalping of a flowable formulation contained in a reservoir defined by packaging material comprising the step of interposing an inner cyclic olefin copolymer layer between the flowable formulation and additional layers of the packaging material.

20. The method of claim 19 wherein the inner cyclic olefin copolymer layer comprises a coextruded layer of two or more cyclic olefin copolymers.

21. The method of claim 19 wherein the inner cyclic olefin copolymer layer comprises a blend of two or more cyclic olefin copolymers.
